(19) United States
(12) Patent Application Publication
(10) Pub. No.: US 2025/0262880 A1
(43) Pub. Date: Aug. 21, 2025

(54) LIQUID DISCHARGE DEVICE

(71) Applicant: SEIKO EPSON CORPORATION, Tokyo (JP)

(72) Inventor: Hiroshi SHIOBARA, MATSUMOTO-SHI (JP)

(21) Appl. No.: 19/058,901

(22) Filed: Feb. 20, 2025

(30) Foreign Application Priority Data
Feb. 21, 2024 (JP) 2024-024481

(51) Int. Cl. B41J 29/17; B08B 1/16; B08B 1/20; B41J 2/155; B41J 2/165; B41J 11/00

(52) U.S. Cl. CPC B41J 29/17; B08B 1/165; B08B 1/20; B41J 2/155; B41J 2/16511; B41J 11/007; B41P 2235/21

(57) ABSTRACT

A liquid discharge device includes a support unit configured to support a medium, a liquid discharge unit configured to discharge liquid in a discharge direction from a nozzle provided at a nozzle surface onto the medium supported by the support unit, and a moving unit configured to move in a first direction that is a direction intersecting the discharge direction and in a second direction that is a direction opposite to the first direction. The moving unit includes a scraping member configured to scrape off paper dust accumulated below the support unit.

The present application is based on, and claims priority from JP Application Serial Number 2024-024481, filed Feb. 21, 2024, the disclosure of which is hereby incorporated by reference herein in its entirety.

### BACKGROUND

### 1. Technical Field

The present disclosure relates to a liquid discharge device that discharges liquid onto a medium.

### 2. Related Art

A liquid spray device disclosed in JP-A-2018-65303 includes a medium support unit that supports a medium at a recording position. The medium support unit includes a transport belt, and moves to a support position and a retreat position by rotating approximately 90 degrees.

Since paper dust adheres to the transport belt, a blade that scrapes off the paper dust adhering to the transport belt by coming into contact with the transport belt may be provided.

However, there is a concern that the paper dust scraped off by the blade falls below the transport belt and causes, for example, an operation failure in a mechanism located below the transport belt.

### SUMMARY

In order to solve the above problems, a liquid discharge device of the present disclosure includes a support unit configured to support a medium, a liquid discharge unit configured to discharge liquid in a discharge direction from a nozzle provided at a nozzle surface onto the medium supported by the support unit, and a moving unit configured to move in a first direction that is a direction intersecting the discharge direction and in a second direction that is a direction opposite to the first direction, wherein the moving unit includes a scraping member configured to scrape off paper dust accumulated below the support unit.

### BRIEF DESCRIPTION OF THE DRAWINGS

FIG. 1 is a diagram illustrating a medium transport path of a printer.

FIG. 2 is a diagram illustrating the medium transport path of the printer.

FIG. 3 is a block diagram illustrating a control system of the printer.

FIG. 4 is a perspective view of a belt unit and a support frame that supports the belt unit.

FIG. 5 is a perspective view of a moving mechanism for moving a cap.

FIG. 6 is a perspective view of the moving mechanism for moving the cap.

FIG. 7 is a perspective view of the moving mechanism for moving the cap.

FIG. 8 is a plan view of a wipe unit and a first guide and a second guide that guide the wipe unit.

FIG. 9 is a perspective view of the first guide and a brush provided in the wipe unit.

FIG. 10 is a side cross-sectional view of the moving mechanism for moving the cap.

FIG. 11 is a sectional side view of the moving mechanism for moving the cap.

FIG. 12 is a flowchart illustrating a flow of a maintenance operation.

### DESCRIPTION OF EMBODIMENTS

Hereinafter, the present disclosure will be described in brief.

A liquid discharge device according to a first aspect includes a support unit configured to support a medium, a liquid discharge unit configured to discharge liquid in a discharge direction from a nozzle provided at a nozzle surface onto the medium supported by the support unit, and a moving unit configured to move in a first direction that is a direction intersecting the discharge direction and in a second direction that is a direction opposite to the first direction, wherein the moving unit includes a scraping member configured to scrape off paper dust accumulated below the support unit.

According to the present aspect, since the paper dust accumulated below the support unit can be scraped off by the scraping member, it is possible to suppress an operation failure of a mechanism arranged below the support unit.

A second aspect is an aspect according to the first aspect, further including an accommodating unit provided below a position where the paper dust is scraped off by the scraping member, the accommodating unit being configured to accommodate the paper dust scraped off by the scraping member.

According to the present aspect, since the scraped paper dust can be accommodated in the accommodating unit, it is possible to prevent the paper dust from being diffused over a wide range.

A third aspect is an aspect according to the first aspect, further including a guide unit provided below the support unit, wherein the guide unit is configured to guide a guided unit provided in the moving unit, the moving unit includes a wiping unit configured to wipe the nozzle surface, and the scraping member is located in the first direction with respect to the guided unit, the scraping member being configured to scrape off the paper dust accumulated on the guide unit when the moving unit moves in the first direction.

According to the present aspect, since the scraping member is located in the first direction with respect to the guided unit and scrapes off the paper dust accumulated on the guide unit when the moving unit moves in the first direction, it is possible to prevent the moving unit from becoming unmovable due to the paper dust when the moving unit moves in the first direction.

A fourth aspect is an aspect according to the third aspect, wherein the scraping member is provided in a state of being inclined with respect to a moving direction of the moving unit.

According to the present aspect, since the scraping member is provided in a state of being inclined with respect to the moving direction of the moving unit, the paper dust can be appropriately removed from the guide unit.

A fifth aspect is an aspect according to the fourth aspect, further including an accommodating unit provided below a position of the guide unit where the paper dust is scraped off by the scraping member, the accommodating unit being configured to accommodate the scraped paper dust, wherein the accommodating unit is provided on a side to which the paper dust scraped off by the scraping member moves with respect to the guide unit.

According to the present aspect, since the scraped paper dust can be accommodated in the accommodating unit, it is possible to prevent the paper dust from being diffused over a wide range. In addition, since the accommodating unit is provided on the side to which the paper dust scraped off by the scraping member moves with respect to the guide unit, the paper dust can be more appropriately accommodated in the accommodating unit.

A sixth aspect is an aspect depending on the first or second aspect, wherein the liquid discharge unit is a line head having a moving direction of the moving unit as a longitudinal direction, the support unit includes a drive roller, a driven roller, and a transport belt which is an endless belt wound between the drive roller and the driven roller, and the transport belt is configured to move between a support position facing the liquid discharge unit and a retreat position separated from the support position.

According to the present aspect, since the transport belt is movable between the support position facing the liquid discharge unit and the retreat position separated from the support position, when the transport belt is at the retreat position, it is possible to perform a treatment such as maintenance of the liquid discharge unit.

A seventh aspect is an aspect according to the sixth aspect, further including a paper dust removing unit that comes into contact with the transport belt, the paper dust removing unit being configured to remove paper dust adhering to the transport belt.

According to the present aspect, since the paper dust removing unit that comes into contact with the transport belt and removes the paper dust adhering to the transport belt is further provided, it is possible to suppress the paper dust adhering to the transport belt from adhering to the nozzle of the liquid discharge unit.

An eighth aspect is an aspect according to any one of the third to fifth aspects, wherein the liquid discharge unit is a line head having a moving direction of the moving unit as a longitudinal direction, the support unit includes a drive roller, a driven roller, and a transport belt which is an endless belt wound between the drive roller and the driven roller, and the transport belt is configured to move between a support position facing the liquid discharge unit and a retreat position separated from the support position.

According to the present aspect, since the transport belt is movable between the support position facing the liquid discharge unit and the retreat position separated from the support position, when the transport belt is at the retreat position, it is possible to perform a treatment such as maintenance of the liquid discharge unit.

A ninth aspect is an aspect according to the eighth aspect, wherein when an end portion in the second direction is set as a home position and wiping of the nozzle surface is performed by the wiping unit, the moving unit is configured to move from the home position in the first direction and scrape off the paper dust by the scraping member during the movement, and move in the second direction toward the home position and wipe the nozzle surface by the wiping unit during the movement.

As described above, the scraping member is located in the first direction with respect to the guided unit, and is configured to scrape the paper dust accumulated on the guide unit when the moving unit moves in the first direction.

In addition, according to the present aspect, since the end portion of the moving unit in the second direction is set as the home position, and the moving unit moves from the home position in the first direction in a case where the nozzle surface is wiped, it is possible to prevent the moving unit from being unable to move when the nozzle surface is wiped.

A tenth aspect is an aspect according to the eighth aspect, further including a paper dust removing unit that comes into contact with the transport belt, the paper dust removing unit being configured to remove paper dust adhering to the transport belt.

According to the present aspect, since the paper dust removing unit that comes into contact with the transport belt and removes the paper dust adhering to the transport belt is further provided, it is possible to suppress the paper dust adhering to the transport belt from adhering to the nozzle of the liquid discharge unit.

An eleventh aspect is an aspect according to the eighth aspect, further including a cap configured to contact the nozzle surface, a moving mechanism configured to move the cap between a facing position at which the cap faces the nozzle surface and a stand-by position that is further away from the guide unit in a horizontal direction than the facing position is, and a sheet member configured to deform in accordance with movement of the cap, wherein the sheet member is configured to cover at least a part of the moving mechanism when the cap is at the stand-by position.

According to the present aspect, it is possible to prevent paper dust from being accumulated on at least a part of the moving mechanism at the stand-by position by the sheet member, and to prevent an operation failure of the cap.

A twelfth aspect is an aspect according to the eleventh aspect, further including a push-up unit configured to push up at least a part of the sheet member from below the sheet member, wherein the push-up unit is configured to push up an end portion of the sheet member close to the guide unit as the cap moves toward the facing position.

According to the present aspect, since the push-up unit pushes up the end portion of the sheet member close to the guide unit, it is possible to drop the paper dust accumulated on the sheet member.

A thirteenth aspect is an aspect according to the eleventh aspect, wherein the moving mechanism includes a push-up unit configured to push up at least a part of the sheet member from below the sheet member, and when the moving mechanism moves the cap toward the facing position, the push-up unit moves below an end portion of the sheet member close to the guide unit and pushes up the end portion.

According to the present aspect, since the push-up unit pushes up the end portion of the sheet member close to the guide unit, it is possible to drop the paper dust accumulated on the sheet member.

A fourteenth aspect is an aspect according to the second or fifth aspect, wherein the accommodating unit is configured to be detachable.

According to the present aspect, since the accommodating unit is configured to be detachable, the paper dust accommodated in the accommodating unit can be easily discarded.

Hereinafter, the present disclosure will be described in detail.

Hereinafter, an inkjet printer 1 that performs recording by discharging ink, which is an example of a liquid, onto a medium represented by a recording sheet will be described as an example of a liquid discharge device. Hereinafter, the inkjet printer 1 will be abbreviated as printer 1.

An X-Y-Z coordinate system illustrated in each figure is an orthogonal coordinate system, and a Y-axis direction is a width direction that intersects with a medium transport direction and is also a device depth direction. In the present embodiment, among side surfaces constituting the periphery of a device body 2, the side surface in a +Y direction is a back surface, and the side surface in a −Y direction is a front surface.

An X-axis direction is a device width direction, and a +X direction is the left side and an −X direction is the right side as viewed by an operator of the printer 1. Further, the −X direction is a medium feed direction from each medium cassette, which will be described later.

A Z-axis direction is a vertical direction, that is, a device height direction, a +Z direction is an upward direction, and a −Z direction is a downward direction.

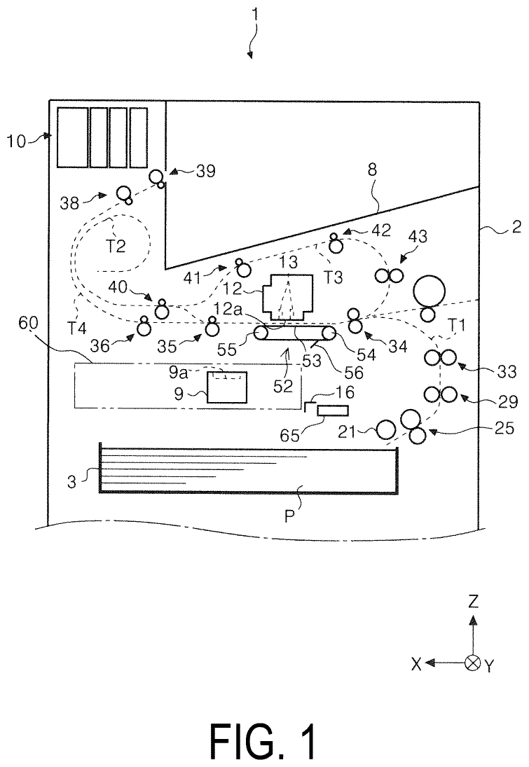

Hereinafter, a direction in which the medium is sent may be referred to as “downstream” and an opposite direction may be referred to as “upstream”. In FIG. 1, the medium transport path is shown by a dashed line. In the printer 1, the medium is transported through the medium transport path shown by the dashed line.

The printer 1 includes a medium cassette 3 in a lower portion of a device body 2 including a line head 12 which will be described below. A reference sign P denotes a medium accommodated in the medium cassette 3.

The medium cassette 3 is provided with a pick roller 21 that feeds the accommodated medium in the −X direction. Further, the medium cassette 3 is provided with a feed roller pair 25 that feeds the medium sent out by the pick roller 21 further downstream. A plurality of medium cassettes (not illustrated) are further provided below the medium cassette 3. In addition, a pick roller (not illustrated) and a feed roller pair (not illustrated) are provided for each of the plurality of medium cassettes (not illustrated).

Hereinafter, unless otherwise specified, it is assumed that a “roller pair” includes a drive roller driven by a power source such as a motor, and a driven roller that rotates in a driven manner in contact with the drive roller.

A reference sign T1 indicates a transport path of the medium which is sent out from the medium cassette 3 and reaches the transport roller pair 34. The medium sent out from the medium cassette 3 receives a feed force from the transport roller pairs 29 and 33 and is sent to the transport roller pair 34.

The medium that receives the feeding force from the transport roller pair 34 is fed between the line head 12, which is an example of a liquid discharge unit, and the transport belt 53, that is, to a recording position facing the line head 12. The transport roller pair 34 constitutes a transport portion that transports the medium between the line head 12 and the transport belt 53.

The line head 12 performs recording by discharging ink, which is an example of liquid, from a nozzle 13 provided in a nozzle surface 12a. In the present embodiment, the discharge direction of the ink from the nozzle 13 is the −Z direction. The line head 12 is an ink discharge head in which a plurality of nozzles 13 that discharge ink are arranged to cover the entire area in the width direction of the medium, and is configured as an ink discharge head that can perform recording over the entire width of the medium without moving in the width direction of the medium. However, the ink discharge head is not limited thereto, and may be a type that is mounted on a carriage and discharges ink while moving in the width direction of the medium.

Further, the recording method is not limited to the inkjet method, and may be an electrophotographic method such as a dot impact method, a laser method, or an LED method.

The line head 12 according to the present embodiment discharges, for example, ink of a plurality of colors. Specifically, in the present embodiment, the plurality of nozzles 13 include a plurality of nozzles 13 that discharge yellow ink, a plurality of nozzles 13 that discharge magenta ink, a plurality of nozzles 13 that discharge cyan ink, and a plurality of nozzles 13 that discharge magenta ink.

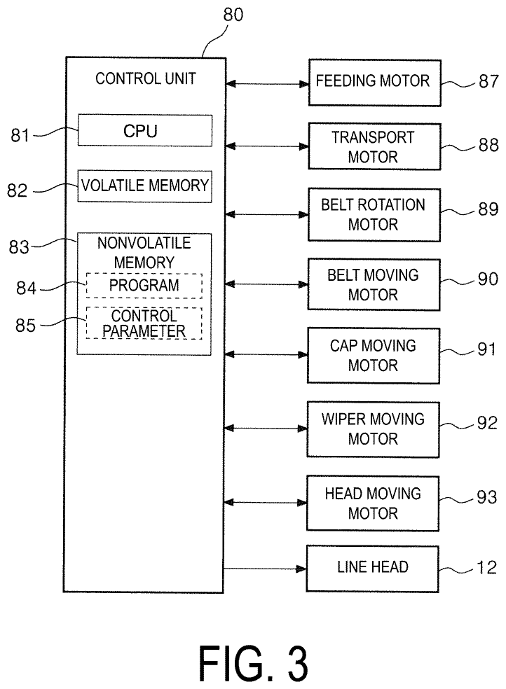

Next, the transport belt 53 is an endless belt which is wound around a first roller 54 which is a drive roller and a second roller 55 which is a driven roller, and is rotated when the first roller 54 is driven by a belt rotation motor 89 (refer to FIG. 3). The medium is transported to the position facing the line head 12 while being adsorbed to a belt surface of the transport belt 53.

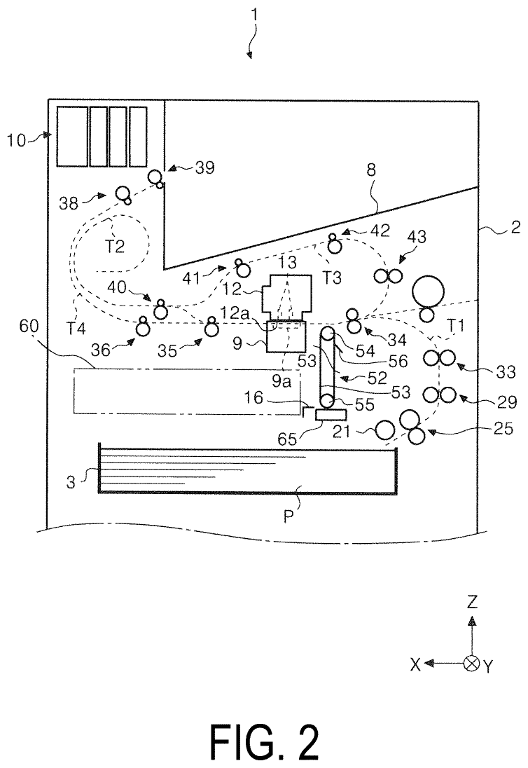

The first roller 54, the second roller 55, and the transport belt 53 constitute a belt unit 52. The belt unit 52 is an example of a support unit that supports a medium. The belt unit 52 uses the first roller 54 as a rotation shaft, and is provided so as to be rotatable by power of a belt moving motor 90 (see FIG. 3). When the belt unit 52 rotates, the transport belt 53 moves between a support position (refer to FIG. 1) facing the line head 12 and a retreat position (refer to FIG. 2) separated from the support position.

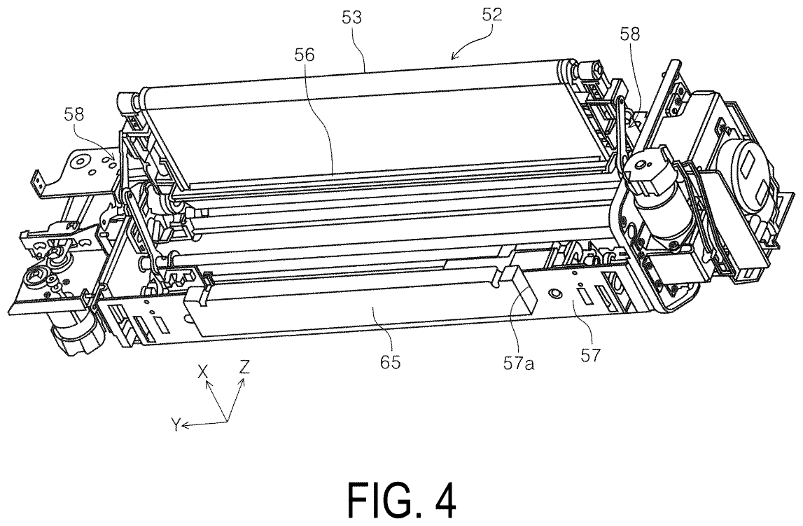

FIG. 4 is a perspective view of the belt unit 52, and a reference sign 57 denotes a support frame that rotatably supports the belt unit 52. Further, in FIG. 4, a reference sign 58 denotes a link mechanism for rotating the belt unit 52. In FIG. 4, the reference sign 57a denotes an opening formed in the support frame 57. An accommodating unit 65, which will be described below, is detachably provided at an opening 57a.

A reference sign 56 denotes a blade serving as a paper dust removing unit that comes into contact with the transport belt 53 to remove paper dust adhering to the transport belt 53. As an example, the blade 56 is a plate-shaped elastic member having a predetermined thickness, is formed of urethane, rubber, or the like, and can be elastically deformed in a state of being in contact with the transport belt 53. Not only paper dust but also foreign matter such as dust may adhere to the transport belt 53, and the blade 56 scrapes off such foreign matter and causes the foreign matter to fall below the transport belt 53. In the present specification, paper dust is treated as a representative example of foreign matter.

The blade 56 constitutes the belt unit 52 and rotates integrally with the belt unit 52. When the belt unit 52 is at the support position, the blade 56 contacts the transport belt 53 from below as illustrated in FIG. 1. Therefore, the paper dust scraped off by the blade 56 falls downward from the blade 56. A moving mechanism 60 and a first guide 16, which will be described below, are arranged below the blade 56.

In FIG. 1, the medium on which the recording is performed on the first surface by the line head 12 is sent toward any one of the transport roller pair 36 and the transport roller pair 40 by the transport roller pair 35 located downstream of the transport belt 53. A path switching flap (not shown) is provided downstream of the transport roller pair 35, and the medium receiving the feed force from the transport roller pair 35 is sent to any one of the transport roller pair 36 and the transport roller pair 40 by this path switching flap.

In a case where recording is not performed on both the first side and the second side opposite to the first side of the medium, that is, in a case where double-sided recording is not performed, the medium is sent from the transport roller pair 35 toward the transport roller pair 36, pass through the ejecting path T4, and are ejected toward an ejecting tray 8. The ejecting path T4 is provided with the transport roller pair 38 and the transport roller pair 39.

When recording is performed on both the first side and the second side opposite to the first side of the medium, that is, when the double-sided recording is performed, the medium is sent from the transport roller pair 35 to the transport roller pair 40 and enters a switchback path T2. Thereafter, a rotation direction of the transport roller pair 40 is switched, the medium enters a reversal path T3, and is sent to the transport roller pair 34 by the transport roller pairs 41, 42, and 43.

A reference sign 10 denotes an ink accommodating unit as a liquid accommodating unit that accommodates ink before discharge. The ink discharged from the line head 12 is supplied from the ink accommodating unit 10 to the line head 12 via a tube (not illustrated). The ink accommodating unit 10 accommodates, for example, ink of black, yellow, magenta, and cyan.

A reference sign 9 denotes a capping unit having a cap 9a that can come into contact with the nozzle surface 12a of the line head 12. The capping unit 9 is displaced between a facing position (refer to FIG. 2) at which the cap 9a faces the nozzle surface 12a of the line head 12 and a stand-by position (refer to FIG. 1) which is horizontally further away from the facing position by power of a cap moving motor 91 (refer to FIG. 3). An ink tube (not illustrated) is coupled to the cap 9a, and the ink ejected to the cap 9a is sent to a waste liquid accommodating unit (not illustrated).

The overall configuration of the printer 1 has been described above, and the control unit 80 will be described below with reference to FIG. 3.

The control unit 80 performs various controls including recording control in the printer 1. In FIG. 3, only components necessary for description in the present specification are illustrated, and illustration of other components is omitted.

As an output system, a feeding motor 87, a transport motor 88, a belt rotation motor 89, a belt moving motor 90, a cap movement motor 91, a wiper moving motor 92, a head moving motor 93, and the line head 12 are electrically coupled to the control unit 80. The feeding motor 87 is a power source for each pick roller and each feed roller pair described above. Further, the transport motor 88 is a power source for each transport roller pair described above.

The head moving motor 93 is a power source for moving the line head 12 forward and backward with respect to the transport belt 53. That is, the line head 12 is provided so as to be displaceable in the Z-axis direction, that is, in a direction of advancing and retreating with respect to the transport belt 53, by a guide unit (not illustrated). The control unit 80 can adjust the position of the line head 12 in the Z-axis direction by controlling the head moving motor 93.

Each motor is a DC motor as an example. Each of the motors is provided with a rotary encoder (not illustrated), and the control unit 80 can detect a rotation direction, a rotation amount, and a rotation speed of each of the motors by the rotary encoder. That is, the control unit 80 can detect the driving direction, the driving amount, and the driving speed of each driving target.

The control unit 80 includes a CPU 81 that executes a computer program, in other words, software, a volatile memory 82, and a non-volatile memory 83. The CPU 81 performs various calculations required to execute a program 84 stored in the non-volatile memory 83. The volatile memory 82 is used as a temporary data storage area. The non-volatile memory 83 stores the program 84 and control parameters 85 required to execute the program 84. The program 84 includes a program that executes various processes to be described later, and the control parameters 85 include parameters for executing the program 84. Various processes to be described later are realized by the control unit 80 executing the program 84.

Next, the moving mechanism 60 that moves the cap 9a between the stand-by position (see FIG. 1) and the facing position (see FIG. 2) will be described.

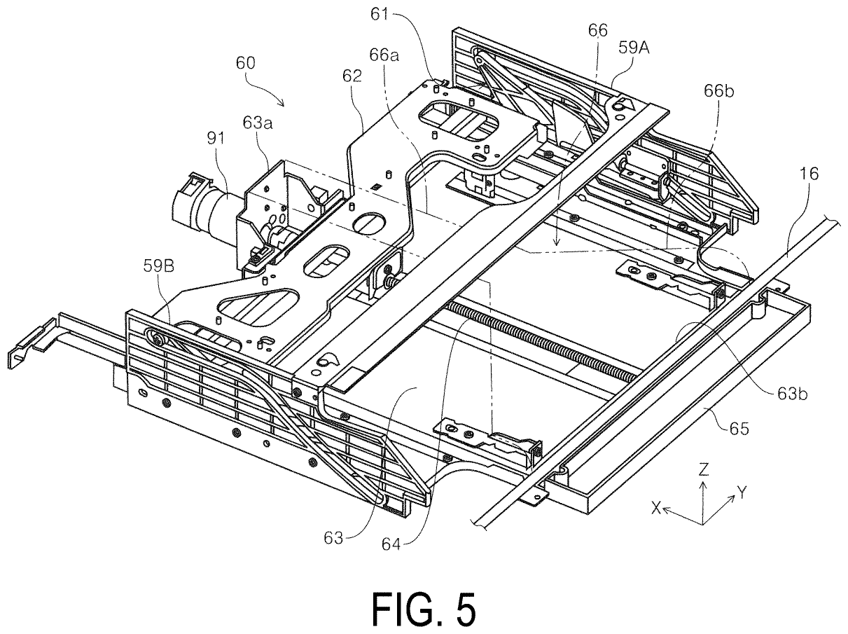

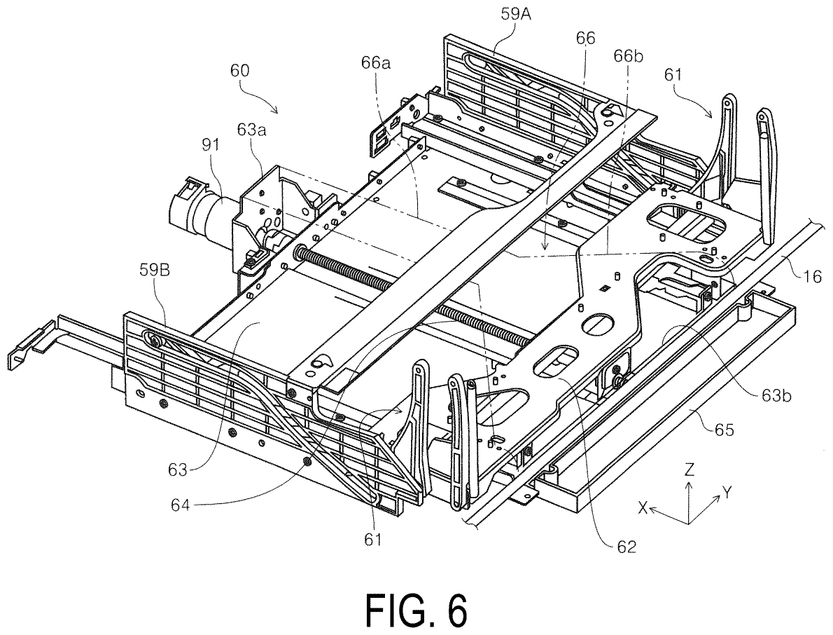

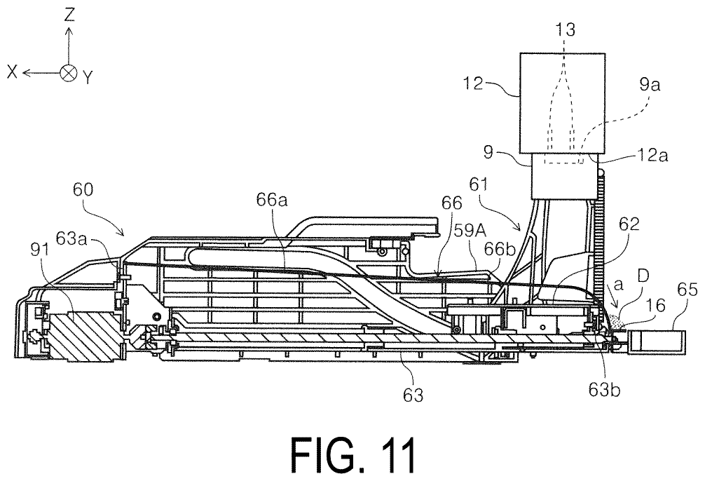

FIGS. 5, 6, and 7 are perspective views of the moving mechanism 60. In FIGS. 5, 6, and 7, the cap 9a is not illustrated. The cap 9a is supported by a link mechanism 61 in a raised state as illustrated in FIGS. 6 and 11.

A base body of the moving mechanism 60 is constituted by a base frame 63 and side frames 59A and 59B. The base frame 63 has a tray shape. The side frames 59A and 59B are frames extending along the X-axis direction, the side frame 59A is provided in the +Y direction with respect to the base frame 63, and the side frame 59B is provided in the −Y direction with respect to the base frame 63. The side frames 59A and 59B guide the link mechanism 61.

A slider 62 that moves along the X-axis direction is provided inside the side frames 59A and 59B. The link mechanisms 61 are provided on both sides of the slider 62 in the Y-axis direction. The link mechanism 61 is engaged with the slider 62, and the slider 62 moves along the X-axis direction to switch the link mechanism 61 between a fallen state (see FIG. 5) and a raised state (see FIG. 6). When the link mechanism 61 falls down, the cap 9a is positioned at the stand-by position (see FIG. 1). When the link mechanism 61 is raised, the cap 9a is positioned at the facing position (see FIG. 2). The link mechanism 61 is a so-called four bar link mechanism, and detailed description of the configuration and operation thereof will be omitted.

The slider 62 is provided with a screw portion (not illustrated in FIGS. 5 to 7), and a ball screw 64 is passed through the screw portion. The ball screw 64 extends in the X-axis direction and rotates by receiving the power of the cap moving motor 91. The slider 62 is moved along the X-axis direction by the rotation of the ball screw 64.

A sheet member 66 is provided at an upper portion of the slider 62. The sheet member 66 will be described below.

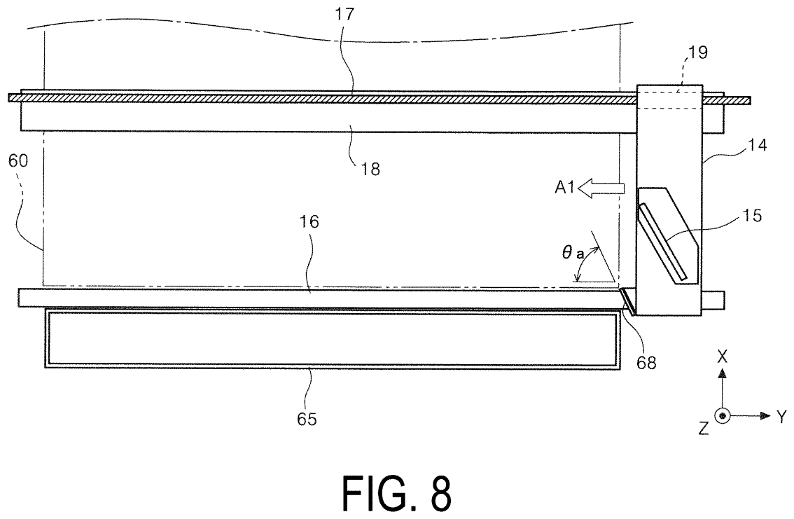

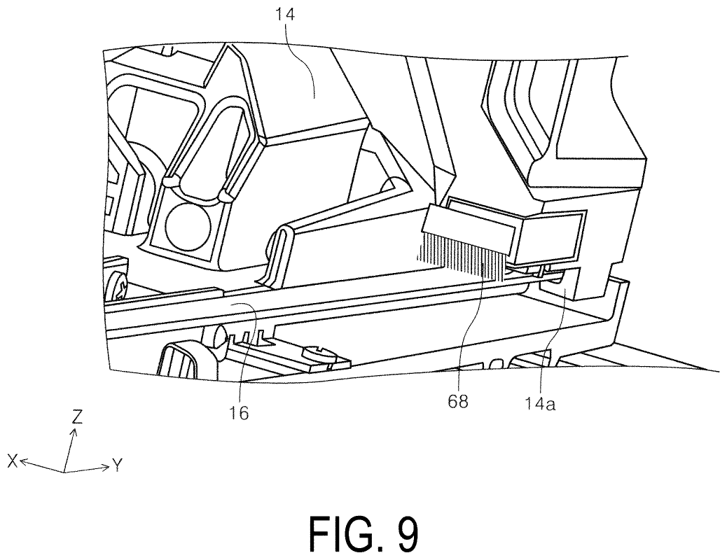

Next, a wipe unit 14 will be described with reference to FIGS. 8 and 9.

The wipe unit 14 is provided to be movable along the Y-axis direction. The wipe unit 14 is an example of a moving unit that can move in the Y-axis direction intersecting the ink discharge direction from the line head 12, that is, the −Z direction. Further, in the Y-axis direction, the −Y direction is an example of a first direction, and the +Y direction is an example of a second direction.

A reference sign 16 denotes a first guide extending along the Y-axis direction, and a reference sign 18 denotes a second guide extending along the Y-axis direction. The first guide 16 is an example of a guide unit provided below the belt unit 52. The upper surfaces of the first guide 16 and the second guide 18 are formed as flat surfaces parallel to the X-Y plane. The wipe unit 14 is supported by the upper surfaces of the first guide 16 and the second guide 18 and is guided in the Y-axis direction.

As illustrated in FIG. 9, the wipe unit 14 includes a sandwiching unit 14a that sandwiches the first guide 16 in the Z-axis direction. The sandwiching unit 14a is an example of a guided unit that is guided by the first guide 16.

In FIG. 8, a reference sign 17 denotes a ball screw extending in the Y-axis direction. The wipe unit 14 has a screw unit 19, and the ball screw 17 is passed through the screw unit 19. The ball screw 17 is rotated by a wiper moving motor 92 (see FIG. 3), whereby the wipe unit 14 is moved along the Y-axis direction.

The wipe unit 14 includes a wiper 15. The wiper 15 is an example of a wiping unit capable of wiping the nozzle surface 12a of the line head 12. The wiper 15 is formed of urethane, rubber, or the like, and can be elastically deformed in a state of being in contact with the nozzle surface 12a.

A brush 68, which is an example of a scraping member, is provided on a side surface of the wipe unit 14 in the −Y direction. As illustrated in FIG. 9, the brush 68 is provided so as to contact the upper surface of the first guide 16 in an elastically deformed state. The brush 68 is formed of a chemical fiber such as nylon, polypropylene, or polyester, a metal fiber, an animal fiber, a plant fiber, or the like.

The brush 68 is provided so as to be inclined at an angle θa with respect to the Y-axis direction as illustrated in FIG. 8. It can be said that the angle θa is an angle formed between the arrangement direction of the bristles of the brush 68 and the Y-axis direction.

The wipe unit 14 sets an end portion in the +Y direction in the movable range as a home position. When wiping the nozzle surface 12a of the line head 12, the line head 12 is at a height position where the nozzle surface 12a does not come into contact with the wiper 15, and in this state, the wipe unit 14 moves to the end portion in the −Y direction. Next, the line head 12 descends to a position where the nozzle surface 12a comes into contact with the wiper 15, and in this state, the wipe unit 14 moves in the +Y direction, so that the wiper 15 wipes the nozzle surface 12a.

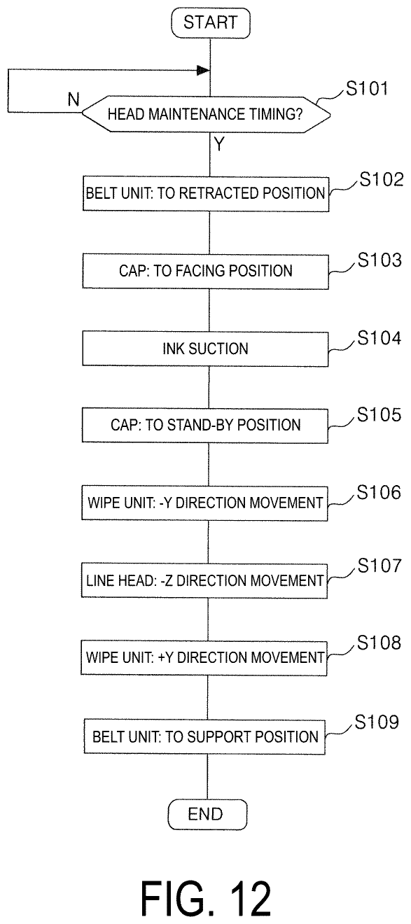

Next, the flow of the head maintenance will be further described with reference to FIG. 12. It is assumed that the process illustrated in FIG. 12 is started in a state where the belt unit 52 is at the support position as illustrated in FIG. 1, the cap 9a is at the stand-by position, and the wipe unit 14 is at the home position as illustrated in FIG. 8. An example of this state is that a recording job is being executed.

When the control unit 80 determines that it is the head maintenance timing (Yes in step S101), the control unit 80 moves the belt unit 52 to the retracted position (step S102). Accordingly, a space for the cap 9a to face the line head 12 is formed.

The head maintenance timing may be, for example, a timing at which a predetermined number of sheets are recorded after a recording job is started.

Next, the control unit 80 moves the cap 9a to the facing position (step S103). As a result, the cap 9a of the capping unit 9 seals the nozzle surface 12a. An ink tube (not illustrated) is coupled to the cap 9a, and a pump (not illustrated) is coupled to the ink tube. The control unit 80 drives the pump in a state where the cap 9a seals the nozzle surface 12a, thereby forming a negative pressure in the cap 9a and sucking the ink from the nozzle 13 (step S104).

Next, the control unit 80 moves the cap 9a to the stand-by position (step S105). Accordingly, a space for the wipe unit 14 to move is formed. Next, the control unit 80 moves the wipe unit 14 from the home position in the −Y direction (step S106), and moves the line head 12 in the −Z direction (step S107). In this state, the control unit 80 moves the wipe unit 14 in the +Y direction (step S108), and wipes the nozzle surface 12a with the wiper 15. Then, the control unit 80 moves the belt unit 52 to the support position (step S109).

When the recording job is completed, the control unit 80 moves the belt unit 52 to the retracted position, moves the cap 9a to the facing position, and seals the nozzle surface 12a with the cap 9a. This state is a recording stand-by state.

Next, the sheet member 66 provided in the upper portion of the moving mechanism 60 will be described.

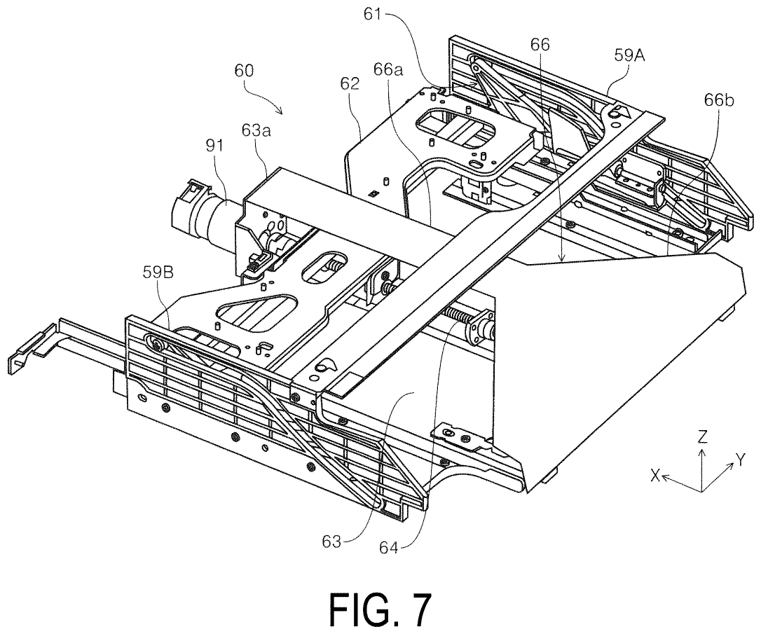

As illustrated in FIGS. 5 to 7, in the present embodiment, the sheet member 66 is provided covering at least the ball screw 64 of the moving mechanism 60. In FIGS. 5 and 6, the sheet member 66 is illustrated by an imaginary line in order to illustrate the configuration of the moving mechanism 60. FIG. 7 depicts the sheet member 66 of FIG. 5 in solid lines.

The sheet member 66 has a linear portion 66a extending along the X-axis direction, and a widened portion 66b which is a portion located in the −X direction with respect to the linear portion 66a and has a shape in which the Y-axis direction is widened toward the −X direction. The sheet member 66 is an elastically deformable sheet member, and as an example, a polypropylene (PP) sheet, a polyethylene terephthalate (PET) sheet, or a polycarbonate (PC) sheet can be adopted.

In the present embodiment, the +X direction end of the linear portion 66a of the sheet member 66 is fixed to a motor attachment portion 63a, which is a portion of the base frame 63 to which the cap moving motor 91 is fixed. The motor attachment portion 63a is a portion formed so as to rise in the +Z direction.

Further, in the present embodiment, the −X direction end portion of the widened portion 66b of the sheet member 66 is fixed to a wall portion 63b formed so as to rise in the +Z direction in the base frame 63.

The sheet member 66 can be fixed to the base frame 63 with screws, an adhesive, a double-sided tape, or the like.

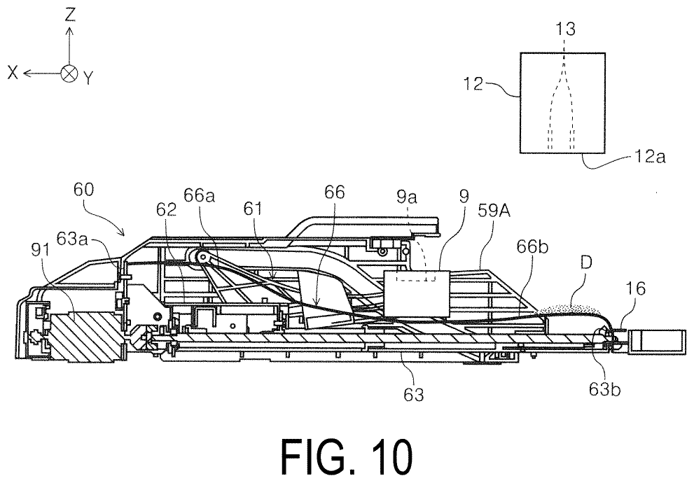

As illustrated in FIGS. 10 and 11, the sheet member 66 is located above the slider 62 constituting the moving mechanism 60 and below the cap 9a.

As illustrated in FIG. 10, when the cap 9a is at the stand-by position, the sheet member 66 is pressed by the cap 9a. Here, as described above, since the paper dust adhering to the transport belt 53 is scraped off by the blade 56 (see FIG. 1), the fallen paper dust is accumulated on the sheet member 66. In FIG. 10, a reference sign D schematically indicates paper dust accumulated on the sheet member 66.

When the cap 9a moves toward the facing position from this state, as illustrated in the change from FIG. 10 to FIG. 11, the pressing of the sheet member 66 by the cap 9a is released, and the −X direction end portion of the sheet member 66 is pushed up by the slider 62. As a result, as indicated by an arrow a in FIG. 11, the paper dust D accumulated on the sheet member 66 moves in the −X direction and is accumulated on the first guide 16.

In order to obtain a plurality of effects of pushing up the sheet member 66 by the slider 62, the reciprocating operation of the slider 62 may be performed a plurality of times at the end portion in the −X direction of the moving range of the slider 62.

Here, as described with reference to FIGS. 8 and 9, the wipe unit 14 is provided with the brush 68 that comes into contact with the first guide 16. Accordingly, when the wipe unit 14 moves in the −Y direction in a state where the paper dust D is accumulated on the first guide 16 (step S106 in FIG. 12), the paper dust D accumulated on the first guide 16 is scraped off by the brush 68.

In the present embodiment, since the brush 68 is provided in a state of being inclined at the angle θa as illustrated in FIG. 8, the paper dust D scraped off by the brush 68 moving in the −Y direction moves in the −X direction. An accommodating unit 65 capable of accommodating the paper dust D is provided in the −X direction with respect to the first guide 16. Therefore, the paper dust D scraped off by the brush 68 can enter the accommodating unit 65.

Here, in the present embodiment, the brush 68 is provided in the −Y direction with respect to the wipe unit 14, that is, provided in the −Y direction with respect to the sandwiching unit 14a (refer to FIG. 9). The home position of the wipe unit 14 is at the end in the +Y direction, and the wipe unit 14 moves from the home position in the −Y direction during the wiping operation (step S106 in FIG. 12). Therefore, the paper dust D is scraped off by the brush 68 before the paper dust D is caught by the sandwiching unit 14a, and thus it is possible to suppress an operation failure of the wipe unit 14.

When the wipe unit 14 is moved to remove the paper dust accumulated on the first guide 16 by the brush 68, the wiping of the nozzle surface 12a by the wiper 15 may not be performed. That is, the wipe unit 14 may be moved only to remove the paper dust accumulated on the first guide 16 by the brush 68.

Hereinafter, operational effects of the printer 1 according to the embodiment will be described.

The printer 1 according to the present embodiment includes the wipe unit 14 that is movable in the −Y direction and the +Y direction. The wipe unit 14 has the brush 68 capable of scraping off the paper powder accumulated below the belt unit 52.

Since the brush 68 can scrape off the paper dust accumulated below the belt unit 52, it is possible to suppress the operation failure of the mechanism arranged below the belt unit 52.

In the present embodiment, the brush 68 scrapes off the paper dust accumulated on the first guide 16, thereby suppressing the operation failure of the wipe unit 14. However, the present disclosure is not limited thereto, and the brush 68 may scrape off the paper dust accumulated on other portions, thereby suppressing the operation failure of other operation mechanisms.

In addition, the printer 1 according to the embodiment includes the accommodating unit 65 which is provided below the portion where the paper dust is scraped off by the brush 68, and can accommodate the paper dust scraped off by the brush 68. Accordingly, since the scraped paper dust can be accommodated in the accommodating unit 65, it is possible to suppress the paper dust from being diffused over a wide range.

The arrangement position of the accommodating unit 65 is not limited to the position illustrated in the present embodiment, and may be another position where the paper dust scraped off by the brush 68 can be accommodated.

The printer 1 according to the present embodiment includes the first guide 16 provided below the belt unit 52. The first guide 16 is configured to guide the sandwiching unit 14a provided in the wipe unit 14. The wipe unit 14 has the wiper 15 capable of wiping the nozzle surface 12a.

The brush 68 is located in the −Y direction with respect to the sandwiching unit 14a, and is configured to scrape off the paper dust accumulated on the first guide 16 when the wipe unit 14 moves in the −Y direction. Accordingly, when the wipe unit 14 moves in the −Y direction as described above, it is possible to prevent the wipe unit 14 from being unable to move due to the paper dust.

Further, in the present embodiment, the brush 68 is provided in a state of being inclined with respect to the Y-axis direction which is the moving direction of the wipe unit 14. Accordingly, the paper dust can be appropriately removed from the first guide 16.

In the present embodiment, the angle θa in FIG. 8 is less than 90°, but is not limited thereto, and may be 90° or greater than 90°.

Further, in the printer 1 according to the present embodiment, the accommodating unit 65 is provided on the side to which the paper dust scraped off by the brush 68 moves with respect to the first guide 16. As a result, the paper dust can be more appropriately accommodated in the accommodating unit 65.

In addition, in the printer 1 according to the embodiment, the liquid discharge unit is the line head 12 in which the moving direction of the wipe unit 14 is the longitudinal direction. The belt unit 52 includes the first roller 54, the second roller 55, and the transport belt 53 which is an endless belt wound between the first roller 54 and the second roller 55. The transport belt 53 is movable between a support position facing the line head 12 and a retracted position away from the support position. Accordingly, when the transport belt 53 is at the retreat position, it is possible to perform a treatment such as maintenance of the line head 12.

In addition, the printer 1 according to the embodiment includes the blade 56 which comes into contact with the transport belt 53 and removes the paper dust attached to the transport belt 53. Accordingly, it is possible to prevent the paper dust attached to the transport belt 53 from being attached to the nozzles 13 of the line head 12.

In addition, in the printer 1 according to the embodiment, an end portion of the wipe unit 14 in the +Y direction is a home position. When the wiper 15 wipes the nozzle surface 12a, the wiper 15 moves from the home position in the −Y direction, and the brush 68 scrapes off the paper dust during the movement. Next, the wiper 15 moves in the +Y direction toward the home position, and wipes the nozzle surface 12a during the movement. Accordingly, it is possible to prevent the wipe unit 14 from becoming immovable.

In addition, the printer 1 according to the present embodiment includes the cap 9a that can come into contact with the nozzle surface 12a, the moving mechanism 60 that moves the cap 9a between the facing position that faces the nozzle surface 12a and the stand-by position that is horizontally further away from the first guide 16 more than the facing position, and the sheet member 66 that can be deformed following the movement of the cap 9a. The sheet member 66 covers the ball screw 64 which is at least a part of the moving mechanism 60 when the cap 9a is located at the stand-by position. Accordingly, it is possible to suppress an operation failure of the cap 9a.

Although the seat member 66 covers the ball screw 64 in the present embodiment, it is needless to say that the seat member 66 may cover other portions.

Further, in the present embodiment, the sheet member 66 has the linear portion 66a extending along the X-axis direction and the widened portion 66b having a shape in which the Y-axis direction is widened toward the −X direction. Since the length of the linear portion 66a is limited to a length necessary to cover the ball screw 64, it is possible to prevent the sheet member 66 from interfering with other portions due to the deformation of the sheet member 66 and causing a problem. In addition, since the widened portion 66b has a shape that widens toward the blade 56 in the X-axis direction, it is possible to more reliably catch paper dust that falls downward from the blade 56.

The sheet member 66 is preferably a black sheet, and the upper surface of the sheet member 66 is preferably subjected to reflection suppression treatment. Accordingly, it is possible to prevent the reflected light from causing erroneous detection of the sensors.

In the printer 1 according to the present embodiment, the moving mechanism 60 includes the slider 62 which is a push-up unit capable of pushing up at least a part of the sheet member 66 from below the sheet member 66. When the moving mechanism 60 moves the cap 9a toward the facing position, the slider 62 moves below the end portion of the sheet member 66 close to the first guide 16 and pushes up the end portion. Accordingly, the paper dust accumulated on the sheet member 66 can be dropped.

The push-up unit capable of pushing up at least a part of the sheet member 66 from below the sheet member 66 is not limited to the slider 62, and may be another portion. For example, the push-up unit may be a raising/lowering member that protrudes upward from below the sheet member 66 when the cap 9a moves toward the facing position and retracts downward when the cap 9a moves to the stand-by position.

Further, the push-up unit capable of pushing up at least a part of the sheet member 66 from below the sheet member 66 may be provided so as to be independently operable under the control of the control portion 80 without being interlocked with the movement of the cap 9a. For example, the raising/lowering member can be raised and lowered by an actuator such as a solenoid or a motor.

In addition, in the printer 1 according to the embodiment, the accommodating unit 65 is configured to be detachable. Accordingly, it is possible to easily discard the paper dust accommodated in the accommodating unit 65. For example, the accommodating unit 65 may be detachably attached to the support frame 57 by a snap-fit structure.

The present disclosure is not limited to the embodiments and modifications described above, and it is obvious that various modifications are possible within the scope of the disclosure described in the claims, and these are also included in the scope of the present disclosure.

What is claimed is:

1. A liquid discharge device comprising:
a support unit configured to support a medium;
a liquid discharge unit configured to discharge liquid in a discharge direction from a nozzle provided at a nozzle surface onto the medium supported by the support unit; and
a moving unit configured to move in a first direction that is a direction intersecting the discharge direction and in a second direction that is a direction opposite to the first direction, wherein
the moving unit includes a scraping member configured to scrape off paper dust accumulated below the support unit.

2. The liquid discharge device according to claim 1, further comprising an accommodating unit provided below a position where the paper dust is scraped off by the scraping member, the accommodating unit being configured to accommodate the paper dust scraped off by the scraping member.

3. The liquid discharge device according to claim 1, further comprising a guide unit provided below the support unit, wherein
the guide unit is configured to guide a guided unit provided in the moving unit,
the moving unit includes a wiping unit configured to wipe the nozzle surface, and
the scraping member is located in the first direction with respect to the guided unit, the scraping member being configured to scrape off the paper dust accumulated on the guide unit when the moving unit moves in the first direction.

4. The liquid discharge device according to claim 3, wherein
the scraping member is provided in a state of being inclined with respect to a moving direction of the moving unit.

5. The liquid discharge device according to claim 4, further comprising an accommodating unit provided below a position of the guide unit where the paper dust is scraped off by the scraping member, the accommodating unit being configured to accommodate the scraped paper dust, wherein
the accommodating unit is provided on a side to which the paper dust scraped off by the scraping member moves with respect to the guide unit.

6. The liquid discharge device according to claim 1, wherein
the liquid discharge unit is a line head having a moving direction of the moving unit as a longitudinal direction,
the support unit includes a drive roller, a driven roller, and a transport belt which is an endless belt wound between the drive roller and the driven roller, and
the transport belt is configured to move between a support position facing the liquid discharge unit and a retreat position separated from the support position.

7. The liquid discharge device according to claim 6, further comprising a paper dust removing unit that comes into contact with the transport belt, the paper dust removing unit being configured to remove paper dust adhering to the transport belt.

8. The liquid discharge device according to claim 3, wherein
the liquid discharge unit is a line head having a moving direction of the moving unit as a longitudinal direction,
the support unit includes a drive roller, a driven roller, and a transport belt which is an endless belt wound between the drive roller and the driven roller, and
the transport belt is configured to move between a support position facing the liquid discharge unit and a retreat position separated from the support position.

9. The liquid discharge device according to claim 8, wherein
when an end portion in the second direction is set as a home position and wiping of the nozzle surface is performed by the wiping unit,
the moving unit is configured to:
move from the home position in the first direction and scrape off the paper dust by the scraping member during the movement; and
move in the second direction toward the home position and wipe the nozzle surface by the wiping unit during the movement.

10. The liquid discharge device according to claim 8, further comprising a paper dust removing unit that comes into contact with the transport belt, the paper dust removing unit being configured to remove paper dust adhering to the transport belt.

11. The liquid discharge device according to claim 8, further comprising a cap configured to contact the nozzle surface;
a moving mechanism configured to move the cap between a facing position at which the cap faces the nozzle surface and a stand-by position that is further away from the guide unit in a horizontal direction than the facing position is; and
a sheet member configured to deform in accordance with movement of the cap, wherein
the sheet member is configured to cover at least a part of the moving mechanism when the cap is at the stand-by position.

12. The liquid discharge device according to claim 11, further comprising a push-up unit configured to push up at least a part of the sheet member from below the sheet member, wherein
the push-up unit is configured to push up an end portion of the sheet member close to the guide unit as the cap moves toward the facing position.

13. The liquid discharge device according to claim 11, wherein
the moving mechanism includes a push-up unit configured to push up at least a part of the sheet member from below the sheet member, and
when the moving mechanism moves the cap toward the facing position, the push-up unit moves below an end portion of the sheet member close to the guide unit and pushes up the end portion.

14. The liquid discharge device according to claim 2, wherein
the accommodating unit is configured to be detachable.
